(19) United States
(12) Patent Application Publication
(10) Pub. No.: US 2018/0211098 A1
(43) Pub. Date: Jul. 26, 2018

(54) FACIAL AUTHENTICATION DEVICE

(71) Applicant: PANASONIC INTELLECTUAL PROPERTY MANAGEMENT CO., LTD., Osaka-shi, Osaka (JP)

(72) Inventors: Shogo TANAKA, Kanagawa (JP); Yoshiyuki MATSUYAMA, Kanagawa (JP); Kenji TABEI, Kanagawa (JP); Hiroaki YOSHIO, Kanagawa (JP)

(73) Assignee: Panasonic Intellectual Property Management Co., Ltd., Osaka-shi, Osaka (JP)

(21) Appl. No.: 15/744,472

(22) PCT Filed: Jul. 5, 2016
(86) PCT No.: PCT/JP2016/003204

§ 371 Date: Jan. 12, 2018

(30) Foreign Application Priority Data
Jul. 30, 2015 (JP) 2015-150416

(51) Int. Cl. G06K 9/00; G06K 9/52; G06K 9/32; G06K 9/62

(52) U.S. Cl. CPC G06K 9/00268; G06K 9/525; G06K 9/3275; G06K 9/00288; G06K 9/6203; G06K 9/3208

(57) ABSTRACT

A facial authentication device (100) includes an image corrector (107) that estimates an orientation of a face based on a center position of the face and a position of imaging unit (101) to correct an image distortion including optical axis deviation with respect to visible light image data such that the orientation of the face coincides with an optical axis direction of imaging unit (101), and a feature amount calculator (105) that extracts a face portion from the image data captured by the imaging unit (101) and calculates a feature amount of the face to output to the image corrector (107), and calculates the feature amount of the face from the image data corrected by the image corrector (107) to output to a face collator (109).

### TECHNICAL FIELD

The present disclosure relates to a facial authentication device that performs face authentication using a face image of a person as a subject.

### BACKGROUND ART

A facial authentication device that performs security management by face authentication of a person is known. In such a facial authentication device, a deviation occurs between a face position and an optical axis of a camera due to a difference in the height of the person to be captured, causing a distortion in the captured face image and resulting in a decrease in an authentication rate.

PTL 1 relates to a face image recognition device and discloses a configuration for inputting an image in which a visual field is enlarged in a height direction of a person as a subject by a wide field lens and correcting the distortion of the input image. In addition, PTL 2 relates to a facial authentication device and discloses a configuration for generating a plurality of three-dimensional face models from a plurality of pieces of face image data captured using a plurality of cameras to generate a two-dimensional synthesized image of a face orientation for collation with the minimum distortion from the plurality of three-dimensional face models.

The present disclosure aims to minimize the distortion of a face image in face authentication without increasing the cost and improve an authentication rate of face authentication by performing face authentication by a simple method using a device with a simple configuration.

### CITATION LIST

### Patent Literature

PTL 1: Japanese Patent Unexamined Publication No. 2001-266152

PTL 2: Japanese Patent Unexamined Publication No. 2009-43065

### SUMMARY OF THE INVENTION

The facial authentication device of the present disclosure includes a camera signal processor that acquires visible light image data from imaging data captured by a camera, a feature amount calculator that extracts a portion of a face of a subject from an image of the visible light image data and calculates a feature amount of the face, a face position detector that detects a center position of the face in the image based on the feature amount of the face, an image corrector that estimates an orientation of the face based on the center position of the face and a position of the camera and corrects an image distortion of the visible light image data including an optical axis deviation such that the orientation of the face coincides with an optical axis direction of the camera to acquire the corrected image data, in which the feature amount calculator calculates a feature amount of the face from the corrected image data, and the device further includes a face collator that performs face recognition by collating the feature amount of the face calculated from the corrected image data with a feature amount of a face image registered in advance.

According to the present disclosure, it is possible to minimize the distortion of a face image in face authentication without increasing the cost and improve an authentication rate of face authentication by performing face authentication by a simple method using a device with a simple configuration.

### BRIEF DESCRIPTION OF DRAWINGS

FIG. 1 is a front view of a facial authentication device according to Embodiment 1 of the present disclosure.

FIG. 2 is a side view of the facial authentication device according to Embodiment 1 of the present disclosure.

FIG. 3 is a block diagram showing a configuration of the facial authentication device according to Embodiment 1 of the present disclosure.

FIG. 4 is a flowchart showing face image distortion correction processing according to Embodiment 1 of the present disclosure.

FIG. 5 is a view showing a center position of a face in image coordinates according to Embodiment 1 of the present disclosure.

FIG. 6 is a view showing a center position of the face in camera coordinates according to Embodiment 1 of the present disclosure.

FIG. 7 is a view showing a positional relationship between an imaging device and the face in world coordinates according to Embodiment 1 of the present disclosure.

FIG. 8 is a view showing a relationship between camera coordinates and world coordinates of a deviation of the face in an optical axis direction according to Embodiment 1 of the present disclosure.

FIG. 9 is a view showing a plane corresponding to a position of the face in world coordinates according to Embodiment 1 of the present disclosure.

FIG. 10 is a diagram showing a face image with or without an optical axis deviation according to Embodiment 1 of the present disclosure.

FIG. 11 is a block diagram showing a configuration of a facial authentication device according to Embodiment 2 of the present disclosure.

FIG. 12A is a view showing a method of obtaining a distance to a subject according to Embodiment 2 of the present disclosure.

FIG. 12B is a view showing a method of obtaining a distance to the subject according to Embodiment 2 of the present disclosure.

FIG. 13 is a view showing a reference position of the face when obtaining a distance to the subject according to Embodiment 2 of the present disclosure.

FIG. 14 is a view showing a distance between the imaging unit and the face of the subject according to Embodiment 2 of the present disclosure.

FIG. 15 is a block diagram showing a configuration of a facial authentication device according to Embodiment 3 of the present disclosure.

FIG. 16 is a flowchart showing an operation of the facial authentication device according to Embodiment 3 of the present disclosure.

FIG. 17 is a diagram showing an orientation of the face in which a vertical length of the face is the longest according to Embodiment 3 of the present disclosure.

FIG. 18 is a view showing vertical length of the face according to Embodiment 3 of the present disclosure.

FIG. 19 is a view showing an image displayed on a display according to Embodiment 3 of the present disclosure.

FIG. 20 is a block diagram showing a configuration of a facial authentication device according to Embodiment 4 of the present disclosure.

FIG. 21 is a diagram showing an image displayed on a display according to Embodiment 4 of the present disclosure.

### DESCRIPTION OF EMBODIMENTS

Hereinafter, embodiments of the present disclosure will be described in detail with reference to drawings as appropriate.

### Embodiment 1

<Structure of Facial Authentication Device>

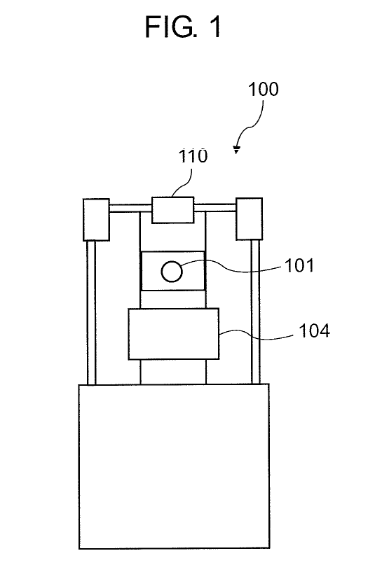

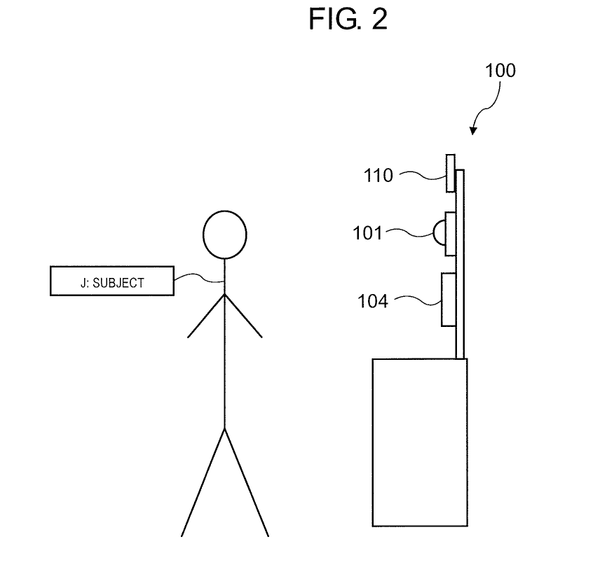

The configuration of facial authentication device 100 according to Embodiment 1 of the present disclosure will be described in detail below with reference to FIGS. 1 to 3.

Facial authentication device 100 includes an imaging unit 101, camera signal processor 102, UI controller 103, display 104, feature amount calculator 105, face position detector 106, image corrector 107, database (DB) 108, face collator 109 and lighter 110.

Imaging unit 101 captures an image of person J as a subject and outputs captured imaging data to camera signal processor 102. Imaging unit 101 typically includes an optical system such as an image sensor and a lens.

Camera signal processor 102 converts analog imaging data input from imaging unit 101 into digital visible light image data and outputs the visible light image data to UI controller 103 and feature amount calculator 105.

UI controller 103 executes display control processing for displaying an image of the visible light image data input from camera signal processor 102 on display 104.

Display 104 displays the face image of subject J by executing display control processing of UI controller 103.

Feature amount calculator 105 extracts a face portion from the visible light image data input from camera signal processor 102, calculates a feature amount of the face image, and outputs the feature amount to face position detector 106. Feature amount calculator 105 calculates a feature amount of a face image from the visible light image data whose image distortion has been corrected by image corrector 107 and outputs the feature amount to the face collator 109. The calculated feature amount is a value corresponding to characteristic portions such as eyes, a nose, and a mouth. Therefore, feature amount calculator 105 may detect feature portions such as eyes, a nose, a mouth, and the like based on the calculated feature amount.

Face position detector 106 detects a center position of the face in the image based on the feature amount input from feature amount calculator 105 and outputs the detection result to image corrector 107.

Image corrector 107 estimates an orientation of the face based on the center position of the face indicated by the detection result input from face position detector 106 and a position of imaging unit 101 stored in advance. Image corrector 107 corrects the image distortion of the visible light image data including an optical axis deviation so that the estimated face orientation coincides with the optical axis direction of imaging unit 101 to output the image data whose image distortion has been corrected (hereinafter, referred to as “corrected image data”) to feature amount calculator 105.

Database (DB) 108 stores the calculated value of the feature amount of the face image in advance.

Face collator 109 performs face recognition by collating the feature amount input from feature amount calculator 105 with the feature amount of the face image registered in advance in database 108. Face collator 109 outputs the result of face authentication.

Lighter 110 irradiates subject J.

<Face Image Distortion Correction Processing>

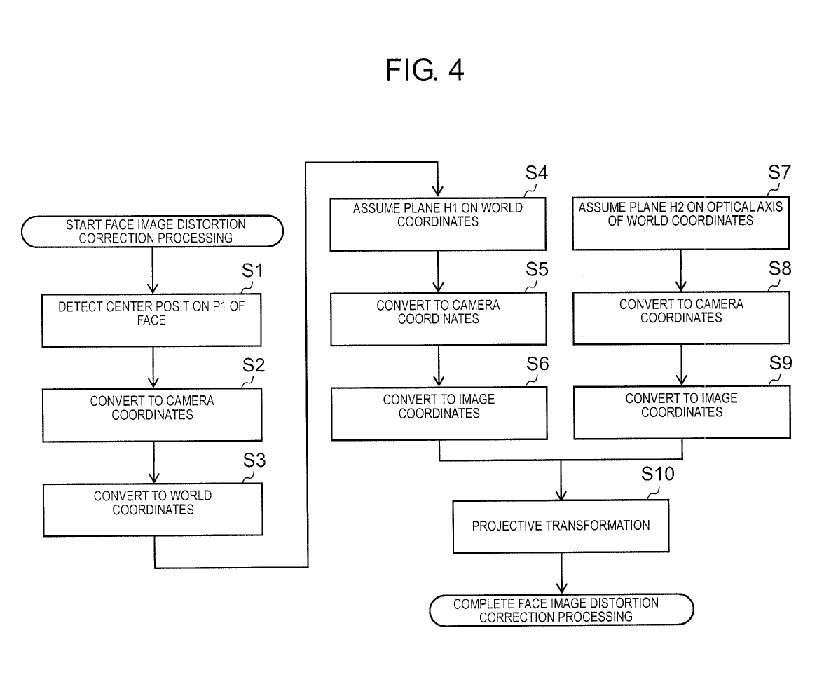

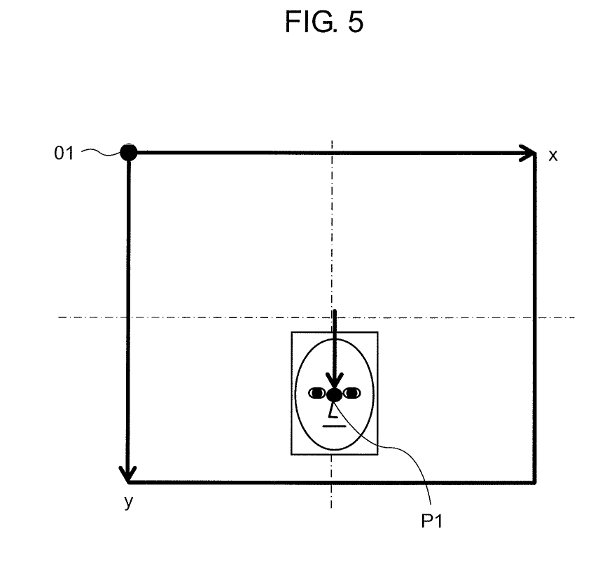

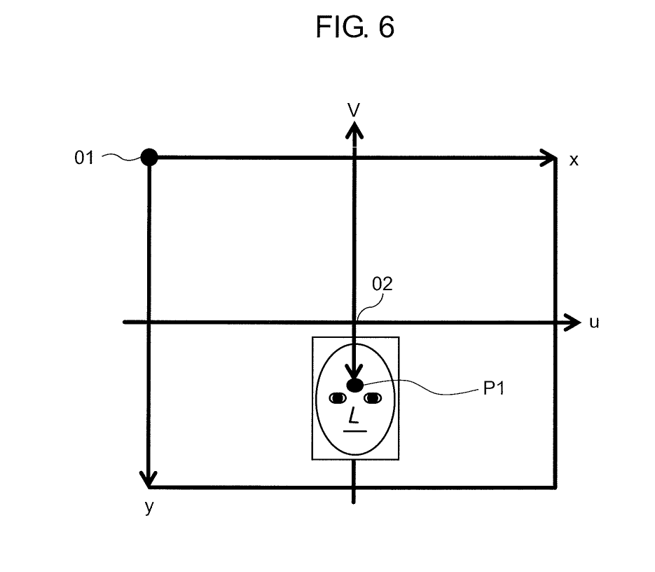

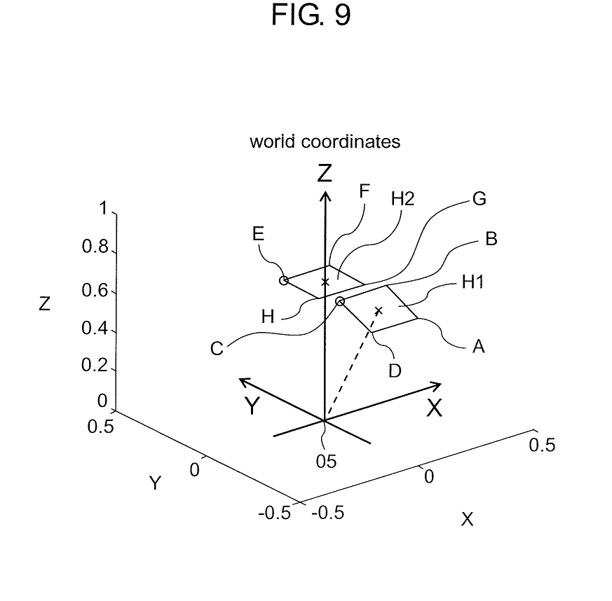

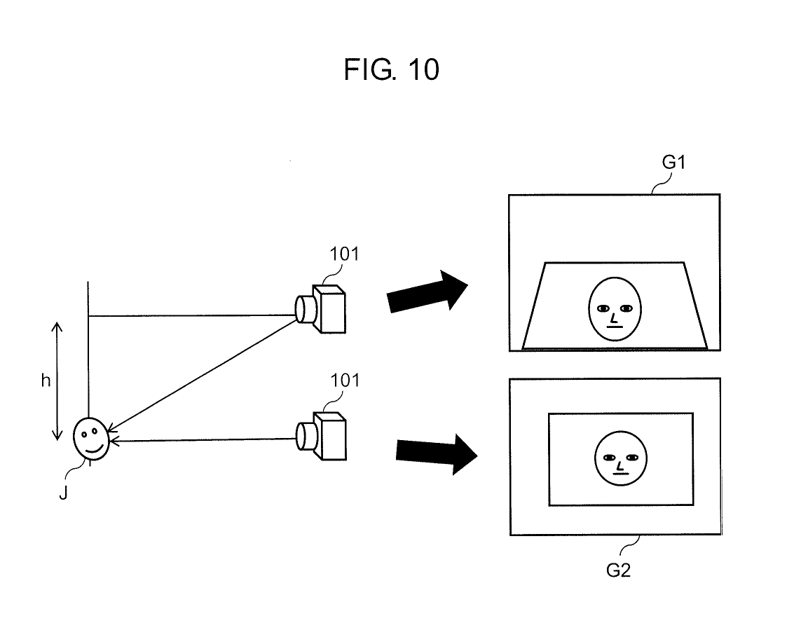

The face image distortion correction processing according to Embodiment 1 of the present disclosure will be described in detail below with reference to FIGS. 4 to 10. FIG. 5 shows image coordinates. FIG. 6 shows camera coordinates. FIG. 9 shows world coordinates. FIG. 10 shows the face image with or without an optical axis deviation.

As shown in FIG. 4, image distortion correction processing is started by inputting the visible light image data from camera signal processor 102 to feature amount calculator 105.

First, feature amount calculator 105 analyzes the input visible light image data to calculate the feature amount of the face image and detects characteristic portions such as the eyes, the nose, and the mouth. As shown in FIG. 5, face position detector 106 detects center position P1 of the face in the image based on the feature amount calculated by feature amount calculator 105 to acquire a y coordinate in the image coordinates of the detected face center position P1 as face center position P1 (S1). As shown in FIG. 5, face position detector 106 sets the upper left corner of the image as origin O1, a lateral direction as an x axis, and a longitudinal direction as the y axis in the image coordinates.

Next, image corrector 107 converts the center position of the face acquired by face position detector 106 into the camera coordinates according to Expression (1) (S2). For simplicity of description, the center of image coordinates is taken as the origin of camera coordinates.

v=(height/2−y)·pixelSize (1)

Here, pixelSize is a size of one pixel of an image sensor, and

height is the vertical length of the image (the height of an image size).

As shown in FIG. 6, image corrector 107 sets the center as origin O2, the lateral direction as a u-axis, and the longitudinal direction as a v-axis in the camera coordinates.

Next, the image corrector 107 converts the center position of the face in the camera coordinates into the world coordinates using Expression (2) (S3).

Y=vZ/f (2)

Here, f is a focal length.

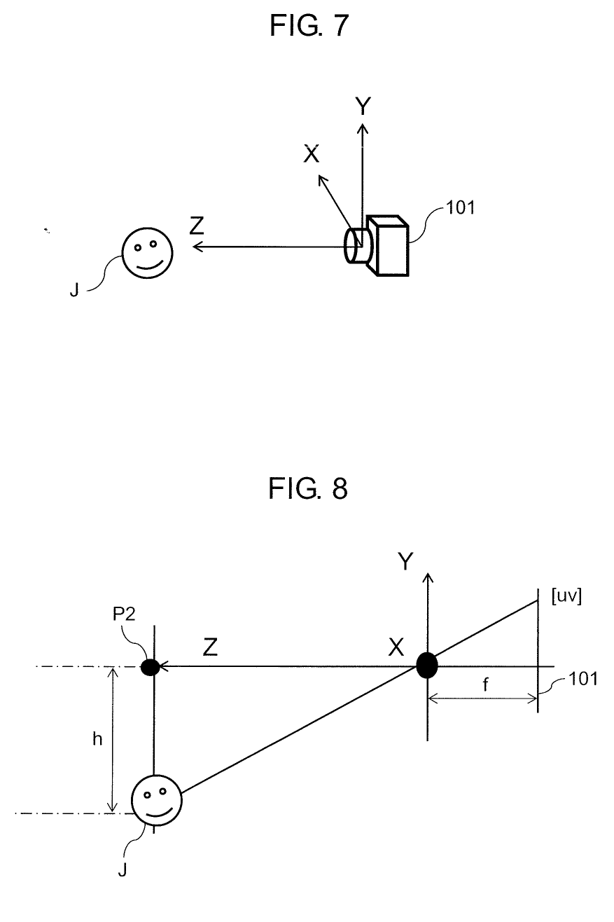

As shown in FIG. 7, image corrector 107 sets the position of imaging unit 101 as the origin and sets world coordinates (X, Y, and Z) with a subject direction as a Z axis from the origin.

As shown in FIG. 8, distance h between position P2 where a straight line parallel to the Y axis passing through the center position of the face intersects with the Z axis and center position P1 of the face deviates in the optical axis direction.

Next, in a case of assuming the face faces imaging unit 101, image corrector 107 obtains orientation θ of the face with respect to imaging unit 101 from Expression (3).

θ=tan⁻¹(h/zz) (3)

Here, his a deviation of the center position of the face in the optical axis direction, and

zz is a distance between imaging unit 101 and the face of the subject.

The image corrector 107 obtains plane H1 having the coordinates of A, B, C, and D in FIG. 9 (S4) by placing a plane with a width of 0.2 m temporarily at the origin of the world coordinates and moving this plane in the world coordinates according to Expression (4).

$$[ \begin{matrix}X \\ Y \\ Z \\ 1\end{matrix} ] = [ \begin{matrix}1 & 0 & 0 & 0 \\ 0 & 1 & 0 & h \\ 0 & 0 & 1 & zz \\ 0 & 0 & 0 & 1\end{matrix} ] [ \begin{matrix}1 & 0 & 0 & 0 \\ 0 & cos θ & - sin θ & 0 \\ 0 & sin θ & cos θ & 0 \\ 0 & 0 & 0 & 1\end{matrix} ] [ \begin{matrix}- .1 & - .1 & .1 & .1 \\ .1 & - .1 & - .1 & .1 \\ 0 & 0 & 0 & 0 \\ 1 & 1 & 1 & 1\end{matrix} ] \qquad ( 4 )$$

In Expression (4), the plane placed at the origin is rotated by θ with the X axis as a rotation axis, and further moved in parallel on the Z axis by distance zz in a direction away from imaging unit 101.

The plane to be placed at the origin is equal to or larger a size at which a calculation error does not become a problem and has a size that does not extend beyond the image size of camera coordinates to be described later.

Next, image corrector 107 converts plane H1 having the coordinates of A, B, C, and D in world coordinates to camera coordinates by Expression (5) (S5).

$$[ \begin{matrix}u \\ v \\ 1\end{matrix} ] = [ \begin{matrix}f & 0 & 0 & 0 \\ 0 & f & 0 & 0 \\ 0 & 0 & 1 & 0\end{matrix} ] [ \begin{matrix}X \\ Y \\ Z \\ 1\end{matrix} ] \qquad ( 5 )$$

Here, f is a focal length.

Next, image corrector 107 converts the plane in the camera coordinates to image coordinates by Expression (6) (S6).

x=width/2+u/pixelSize

y=height/2−v/pixelSize (6)

Here, width is a length of the image in the horizontal direction (the width of the image size),

height is the vertical length of the image (the height of an image size), and

pixelSize is a size of one pixel of the image sensor.

In addition, image corrector 107 obtains plane H2 having the coordinates of E, F, G, and H in FIG. 9 (S7) by temporarily placing a plane at origin O5 of world coordinates and moving this plane in the world coordinates according to Expression (7).

$$[ \begin{matrix}X \\ Y \\ Z \\ 1\end{matrix} ] = [ \begin{matrix}1 & 0 & 0 & 0 \\ 0 & 1 & 0 & 0 \\ 0 & 0 & 1 & zz \\ 0 & 0 & 0 & 1\end{matrix} ] [ \begin{matrix}- .1 & - .1 & .1 & .1 \\ .1 & - .1 & - .1 & .1 \\ 0 & 0 & 0 & 0 \\ 1 & 1 & 1 & 1\end{matrix} ] \qquad ( 7 )$$

In Expression (7), the plane placed at origin O5 is moved on in parallel the Z axis by distance zz in a direction away from imaging unit 101.

The position of plane H2 formed by the coordinates of E, F, G, and H in FIG. 9 corresponds to the original face position.

Next, image corrector 107 converts plane H2 having the coordinates of E, F, G, H in the world coordinates to camera coordinates by Expression (8) (S8).

$$[ \begin{matrix}u \\ v \\ 1\end{matrix} ] = [ \begin{matrix}f & 0 & 0 & 0 \\ 0 & f & 0 & 0 \\ 0 & 0 & 1 & 0\end{matrix} ] [ \begin{matrix}X \\ Y \\ Z \\ 1\end{matrix} ] \qquad ( 8 )$$

Here, f is a focal length.

Next, image corrector 107 converts the plane in the camera coordinates to image coordinates by Expression (9) (S9).

x=width/2+u/pixelSize

y=height/2−v/pixelSize (9)

Here, width is a length of the image in the horizontal direction (the width of the image size),

height is the vertical length of the image (the height of an image size), and

pixelSize is a size of one pixel of the image sensor.

Next, image corrector 107 calculates projective transformation matrix tform using MATrix LABoratory ((MATLAB): Matlab) from Expression (10).

tform=fitgeotrans(movingPoints,fixedPoints,‘Projective’) (10)

Here, movingPoints is the x, y coordinate of the corner of plane H1,

fixedPoints is the x, y coordinate of the corner of plane H2, and

‘Projective’ represents projective transformation by a transformation method.

Then, image corrector 107 performs projective transformation using MATLAB from Expression (11) (S10). Expressions (10) and (11) may also be implemented in a general C language.

B=imwarp(A,tform) (11)

Here, B is the corrected image, and

A is the input image.

By performing such face image distortion correction processing, it is possible to correct distorted image G1 of FIG. 10 so as to be close to image G2 of FIG. 10 obtained by imaging the face of subject J from the front by imaging unit 101. The orientation of the face of subject J in image G2 coincides with the optical axis direction (horizontal direction in FIG. 10) of imaging unit 101.

<Effects>

According to the present embodiment, the orientation of the face is estimated based on the center position of the face and the position of imaging unit 101 and the image distortion of the visible light image data including the optical axis deviation is corrected such that the orientation of the face coincides with the optical axis direction of imaging unit 101, and the face feature amount from corrected image data is calculated to perform face authentication. As a result, since it is possible to perform face authentication by a simple method using a device with a simple configuration, it is possible to minimize the distortion of a face image in face authentication without increasing the cost and improve an authentication rate of face authentication.

### Embodiment 2

<Configuration of Facial Authentication Device>

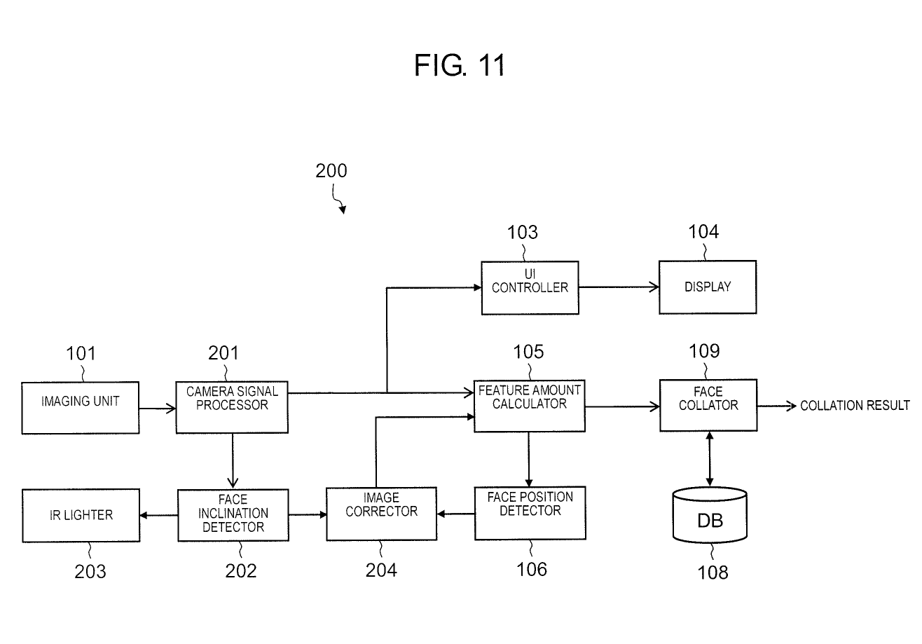

The configuration of facial authentication device 200 according to Embodiment 2 of the present disclosure will be described in detail below with reference to FIG. 11.

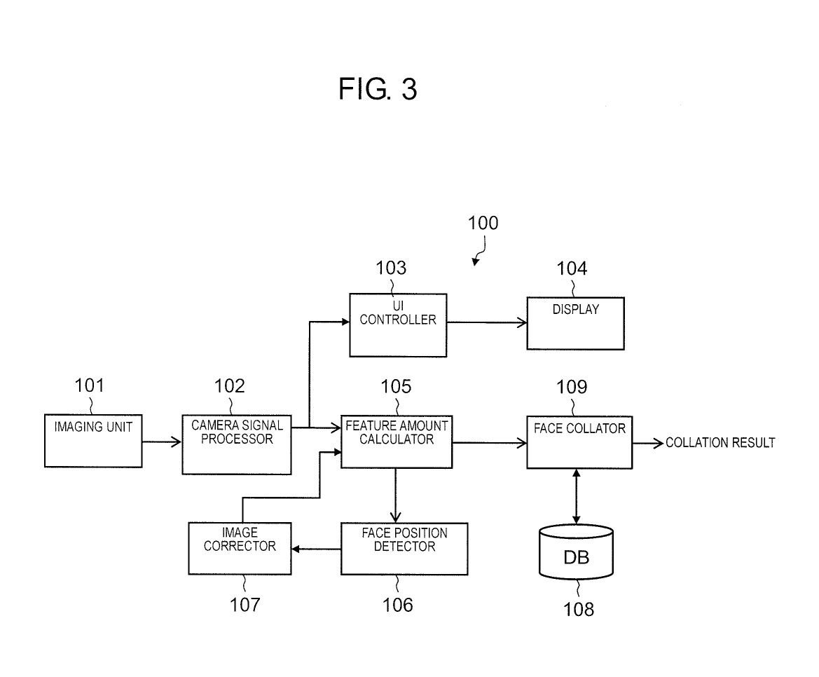

In facial authentication device 200 shown in FIG. 11, components common to facial authentication device 100 shown in FIG. 3 are denoted by the same reference numerals, and the description thereof will be omitted. In comparison with facial authentication device 100 shown in FIG. 3, facial authentication device 200 shown in FIG. 11 adopts a configuration in which camera signal processor 102 and image corrector 107 are deleted, and camera signal processor 201, face inclination detector 202, IR lighter 203, and image corrector 204 are added.

Imaging unit 101 captures an image of person J as a subject and outputs captured imaging data to camera signal processor 201.

Camera signal processor 201 converts the analog imaging data input from imaging unit 101 into digital visible light image data and acquires distance image data from the imaging data. Camera signal processor 201 outputs the visible light image data to face inclination detector 202, UI controller 103, and feature amount calculator 105 to output the distance image data to face inclination detector 202.

UI controller 103 executes display control processing for displaying an image of the visible light image data input from camera signal processor 201 on display 104.

Face inclination detector 202 performs control to cause IR lighter 203 to subject J with infrared light. Face inclination detector 202 detects the inclination of the face of subject J based on the distance image data and the visible light image data input from camera signal processor 201 to output the detection result to image corrector 204.

IR lighter 203 subject J with infrared light under the control of face inclination detector 202.

Based on the center position of the face indicated by the detection result input from face position detector 106, the position of imaging unit 101 stored in advance, and the inclination of the face indicated by the detection result input from face inclination detector 202, image corrector 204 estimates the face. Image corrector 204 corrects the image distortion of the visible light image data including the optical axis deviation so that the estimated face orientation coincides with the optical axis direction of imaging unit 101 to output the corrected image data to feature amount calculator 105.

Feature amount calculator 105 calculates the feature amount of the face image from the corrected image data to output to face collator 109. Since the configuration of feature amount calculator 105 other than the above is the same as that of feature amount calculator 105 of Embodiment 1, the description thereof will be omitted.

Face position detector 106 detects a center position of the face in the image based on the feature amount input from feature amount calculator 105 and outputs the detection result to image corrector 204.

<Face Image Distortion Correction Processing>

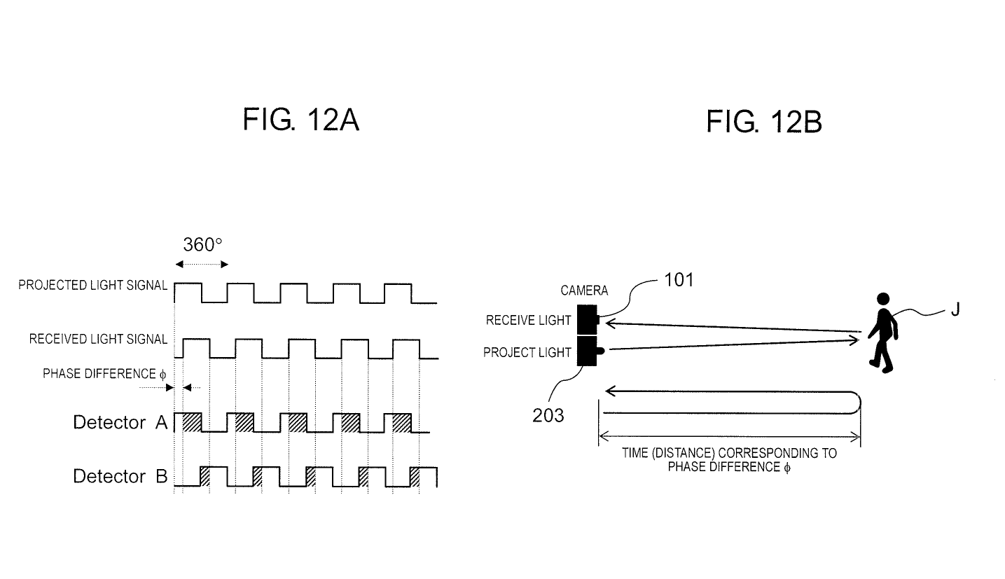

The face image distortion correction processing according to Embodiment 2 of the present disclosure will be described in detail below with reference to FIGS. 12 to 14.

As shown in FIG. 12B, IR lighter 203 irradiates subject J with infrared light. As shown in FIG. 12A, the infrared light (projected light signal) and a distance image signal (received light signal) irradiated by IR lighter 203 generate phase difference ϕ.

Face inclination detector 202 detects the distance to subject J by phase difference ϕ.

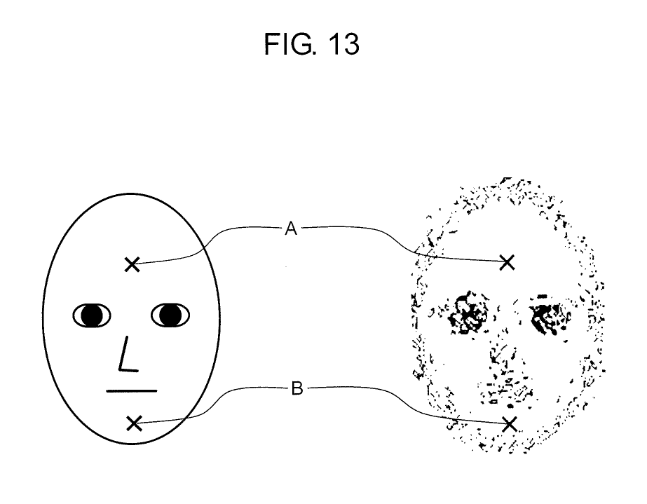

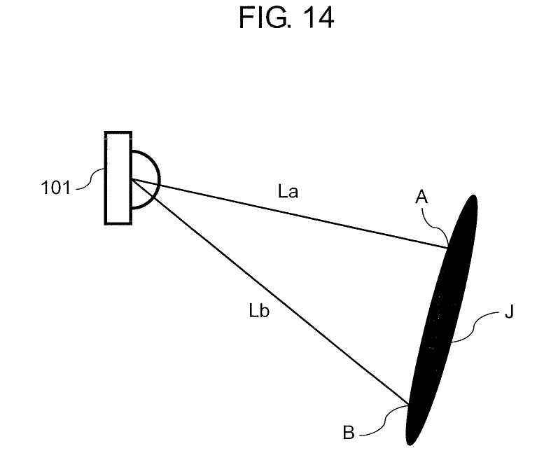

Face inclination detector 202 generates a visible light image from the visible light image signal input from camera signal processor 201. As shown in FIG. 13, face inclination detector 202 extracts position coordinates of forehead A and jaw B of the generated visible light image. Then, as shown in FIG. 14, face inclination detector 202 obtains the above phase difference ϕ in the infrared light irradiated on forehead A and the distance image signal thereof, and the infrared light irradiated on jaw B and the distance image signal thereof. Face inclination detector 202 detects distance La between facial authentication device 100 and forehead A, and distance Lb between facial authentication device 100 and jaw B corresponding to the obtained phase difference ϕ.

In the case of distance La>distance Lb, it is indicated that the face faces downward with respect to the camera direction. In addition, in the case of distance La<distance Lb (in the case of FIG. 14), it means that the face is facing upward with respect to the camera direction. Further, in the case of distance La=distance Lb, it means that the face faces the front (camera direction).

Face inclination detector 202 may obtain inclination θ of the face from the difference between distance La and distance Lb by holding a table storing the difference between distance La and distance Lb in association with orientation θ of the face in advance.

Image corrector 204 may correct the distortion of the face accurately as compared with Embodiment 1 by substituting orientation θ of the face obtained from the difference between distance La and distance Lb to θ in the above Expression (4).

Processing after acquiring the coordinates of A, B, C, and D by Expression (4) is the same as in Embodiment 1, thus the description thereof will be omitted.

<Effects>

According to the present embodiment, by detecting the inclination of the face and correcting the image distortion of the visible light image data by using the inclination of the face, in addition to the effects of Embodiment 1, it is possible to further suppress the distortion of the face image and further improve the authentication rate of the face authentication, as compared with Embodiment 1.

In the present embodiment, the visible light image data and the distance image data are obtained with one facial authentication device, but the visible light image data and the distance image data may be acquired by separate devices.

In addition, in the present embodiment, the distances from imaging unit 101 of the two upper and lower points of forehead A and the jaw B are obtained, but the distances from imaging unit 101 on the two left and right points of the left and right cheekbones or the like may be obtained. In this case, it is possible to correct the orientation and inclination of the face in the horizontal direction.

### Embodiment 3

<Configuration of Facial Authentication Device>

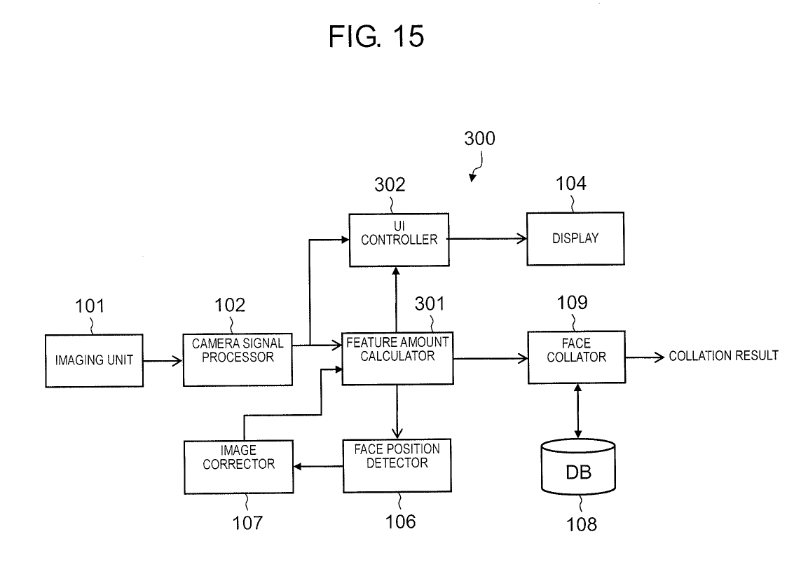

The configuration of facial authentication device 300 according to Embodiment 3 of the present disclosure will be described in detail below with reference to FIG. 15.

In facial authentication device 300 shown in FIG. 15, components common to facial authentication device 100 shown in FIG. 3 are denoted by the same reference numerals, and the description thereof will be omitted. In comparison with facial authentication device 100 shown in FIG. 3, facial authentication device 300 shown in FIG. 15 adopts a configuration in which feature amount calculator 105 and UI controller 103 are deleted, and feature amount calculator 301 and UI controller 302 are added.

Camera signal processor 102 converts the analog imaging data input from imaging unit 101 into digital visible light image data to output the visible light image data to feature amount calculator 301 and UI controller 302.

UI controller 302 executes display control processing for displaying an image of the visible light image data input from camera signal processor 102 on display 104. UI controller 302 causes display 104 to display “OK” and “NG”. UI controller 302 turns on the display of “NG” displayed on display 104 until the best shot signal indicating that an image is the best shot is input from feature amount calculator 301 and turns on the display of “OK” displayed on display 104 when the best shot signal indicating that an image is the best shot is input from feature amount calculator 301.

Display 104 displays the face image of subject J by executing the display control processing of UI controller 302 and displays the displays “OK” and “NG”.

Feature amount calculator 301 extracts a face portion from the visible light image data input from camera signal processor 102, calculates a feature amount of the face image, and repeatedly calculates vertical length Lc of the face image according to vertical motion of the face of the subject based on the calculated feature amount. Feature amount calculator 301 acquires a face image in which repeatedly calculated length Lc is the longest as the best shot. Specifically, feature amount calculator 301 stores the calculation result of the past length Lc, estimates length Lc as the longest value if the longest value is not updated for a fixed time, sets a value obtained by multiplying the longest value of the estimated length Lc by a predetermined coefficient (for example, 0.95) as a threshold value, and acquires a case where length Lc exceeds the threshold value as the best shot. Then, feature amount calculator 301 outputs the feature amount of the face image in the best shot to face position detector 106 and outputs the best shot signal to UI controller 302. Since the configuration other than the above in feature amount calculator 301 is the same as the configuration of feature amount calculator 105, the description thereof will be omitted.

Face position detector 106 detects a center position of the face in the image based on the feature amount input from feature amount calculator 301 and outputs the detection result to image corrector 107.

Image corrector 107 estimates an orientation of the face based on the center position of the face indicated by the detection result input from face position detector 106 and a position of imaging unit 101 stored in advance. Image corrector 107 corrects the image distortion of the visible light image data including the optical axis deviation so that the estimated face orientation coincides with the optical axis direction of imaging unit 101 to output the corrected image data to feature amount calculator 301.

Face collator 109 performs face recognition by collating the feature amount input from feature amount calculator 301 with the feature amount of the face image registered in advance in database 108. Face collator 109 outputs the result of face authentication.

<Operation of Facial Authentication Device>

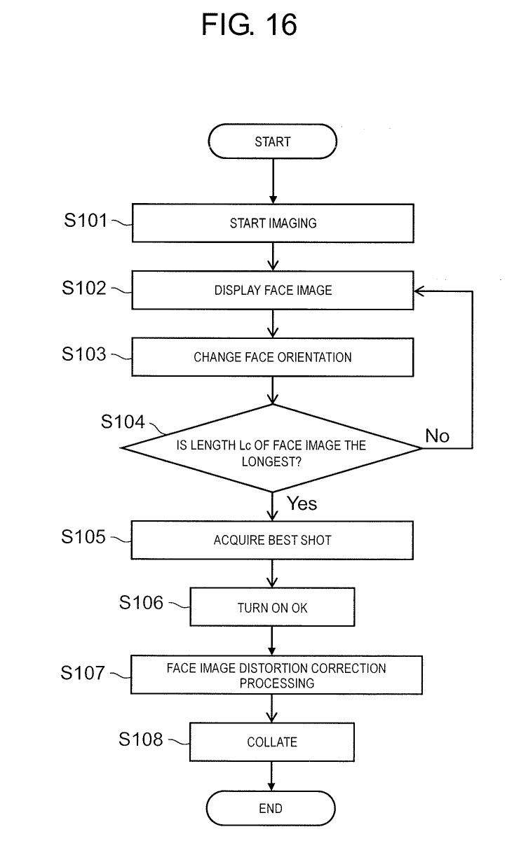

The operation of facial authentication device 300 according to Embodiment 3 of the present disclosure will be described in detail below with reference to FIGS. 16 to 19.

First, facial authentication device 300 starts imaging with imaging unit 101 (S101).

Next, display 104 displays the face image captured by imaging unit 101 (S102).

Next, subject J changes the face orientation by not turning on the “OK” displayed on display 104 (S103).

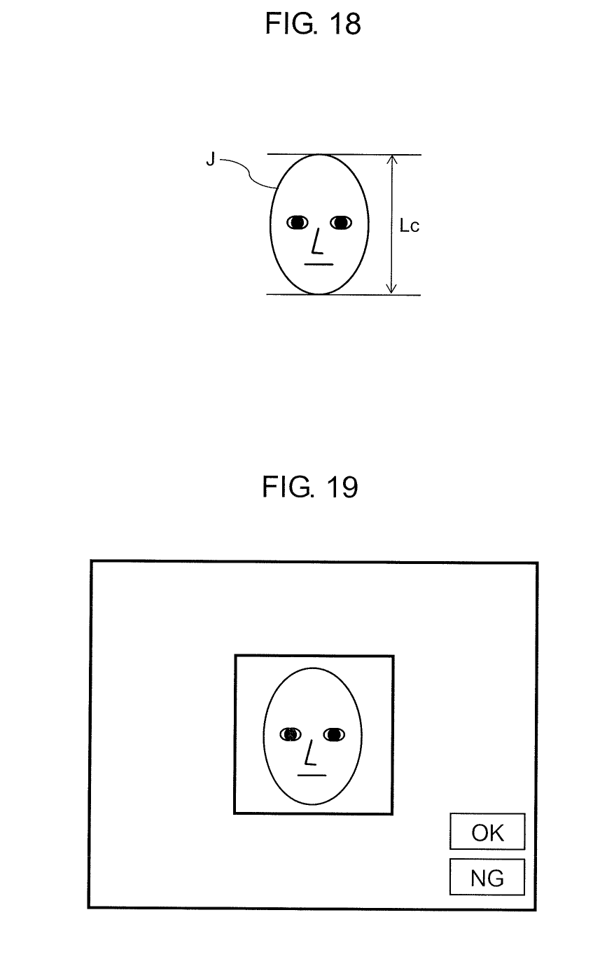

Next, feature amount calculator 301 repeatedly calculates vertical length Lc (see FIG. 18) of the face image based on the feature amount of the face image and determines whether or not length Lc of the face image is the longest (S104).

In a case where length Lc of the face image is not the longest (S104: No), feature amount calculator 301 returns to the processing of S102.

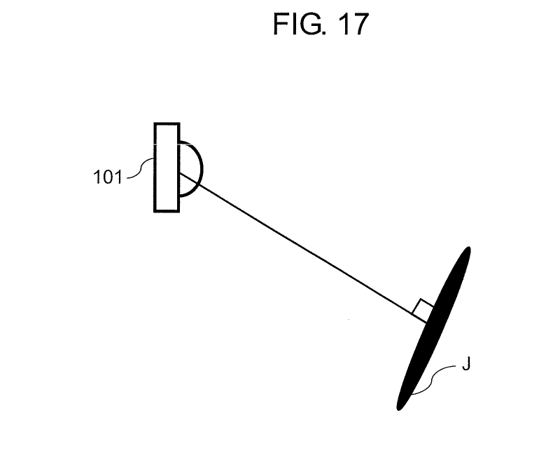

On the other hand, in a case where length Lc of the face image is the longest (S104: Yes), feature amount calculator 301 acquires the face image having the longest length Lc as the best shot (S105). In a case where length Lc is the longest, as shown in FIG. 17, it is when the face faces imaging unit 101.

Next, as shown in FIG. 19, display 104 turns on the display of “OK” (S106).

Next, feature amount calculator 301 and image corrector 107 execute face image distortion correction processing (S107). Since the face image distortion correction processing in the present embodiment is the same processing as the face image distortion correction processing in Embodiment 1, the description thereof will be omitted.

Next, face collator 109 performs face recognition by collating the feature amount input from feature amount calculator 301 with the feature amount of the face image registered in advance in database 108 (S108).

<Effects>

According to the present embodiment, by executing face image distortion correction processing in a case where the length of the face image in the vertical direction is the longest, in addition to the effects of Embodiment 1, it is possible to further suppress the distortion of the face image and further improve the authentication rate of the face authentication, as compared with Embodiment 1.

In addition, according to the present embodiment, a user who is a subject may determine whether or not a distortion of a face image may be corrected by looking at the display of “OK” or “NG” on display 104.

### Embodiment 4

<Configuration of Facial Authentication Device>

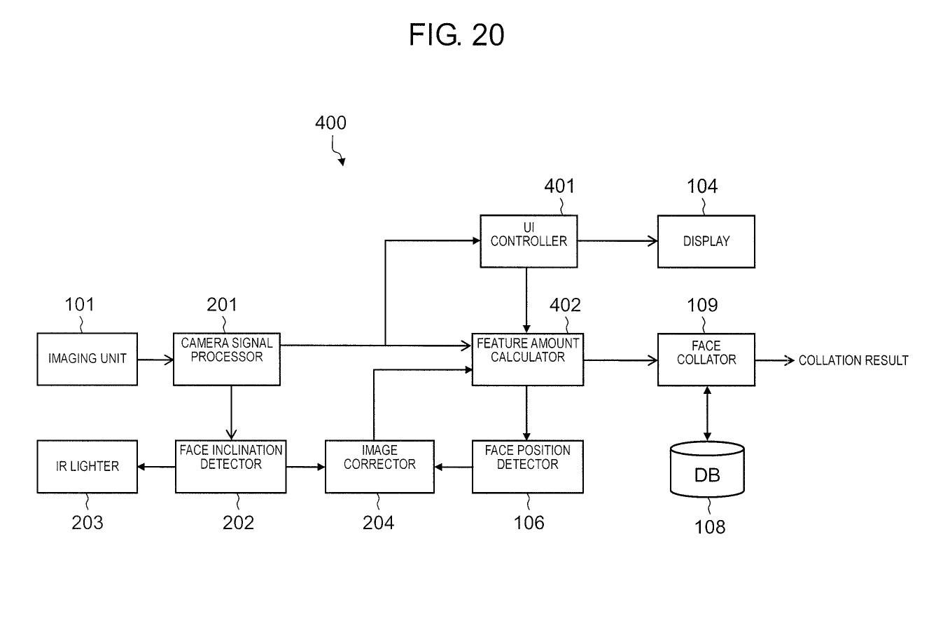

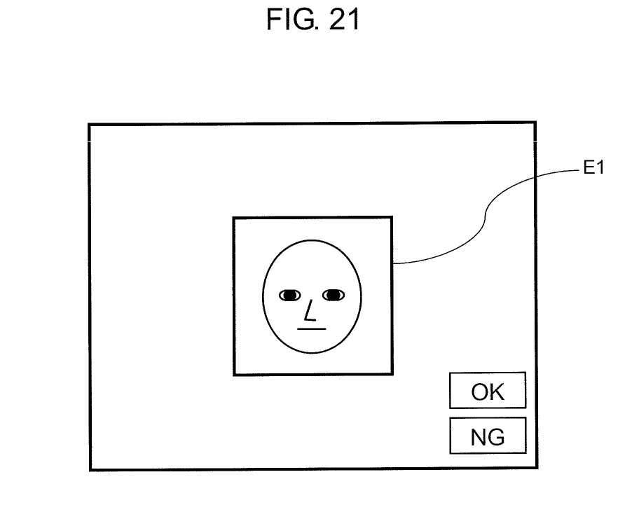

The configuration of facial authentication device 400 according to Embodiment 4 of the present disclosure will be described in detail below with reference to FIGS. 20 and 21.

In facial authentication device 400 shown in FIG. 20, components common to facial authentication device 200 shown in FIG. 11 are denoted by the same reference numerals, and the description thereof will be omitted. In comparison with facial authentication device 200 shown in FIG. 11, facial authentication device 400 shown in FIG. 20 adopts a configuration in which feature amount calculator 105 and UI controller 103 are deleted, and UI controller 401 and feature amount calculator 402 are added.

Camera signal processor 201 converts the analog imaging data input from imaging unit 101 into digital visible light image data and acquires distance image data from the imaging data. Camera signal processor 201 outputs the visible light image data to face inclination detector 202, UI controller 401, and feature amount calculator 402 to output the distance image data to face inclination detector 202.

UI controller 401 executes display control processing for displaying an image of the visible light image data input from camera signal processor 201 on display 104. UI controller 401 causes display 104 to display “OK” and “NG”. When displaying the face image on display 104, the UI controller 401 determines whether or not the face image falls within area E1 having a predetermined size on the display screen, as shown in FIG. 21. In a case where the face image falls within area E1, UI controller 401 turns on the display of “OK” displayed on the display 104 as shown in FIG. 21 to output a trigger signal for starting the face image distortion correction processing to feature amount calculator 402. In a case where the face image protrudes from area E1, UI controller 401 turns on the display of “NG” displayed on display 104.

When a trigger signal is input from UI controller 401, feature amount calculator 402 extracts a face portion from the visible light image data input from camera signal processor 201 and calculates a feature amount of the face image to output to face position detector 106. Since the configuration other than the above in feature amount calculator 402 is the same as the configuration of feature amount calculator 105, the description thereof will be omitted.

The face image distortion correction processing of the present embodiment is the same processing as the face image distortion correction processing of Embodiment 2 except that face image distortion correction processing is started when a trigger signal is input to feature amount calculator 402.

<Effects>

According to the present embodiment, by correcting the orientation of the face and the inclination of the face with respect to the visible light image data in which the face image falls within a predetermined area of the display screen, in addition to the effect of Embodiment 2, it is possible to further suppress the distortion of the face image and further improve the authentication rate of the face authentication, as compared with Embodiment 2.

In addition, according to the present embodiment, a user who is a subject may determine whether or not a distortion of a face image may be corrected by looking at the display of “OK” or “NG” on display 104.

In the present embodiment, the visible light image data and the distance image data are obtained with one facial authentication device, but the visible light image data and the distance image data may be acquired by separate devices.

In addition, in the present embodiment, the distances from imaging unit 101 of the two upper and lower points of forehead A and the jaw B are obtained, but the distances from imaging unit 101 on the two left and right points of the left and right cheekbones or the like may be obtained. In this case, it is possible to correct the orientation and inclination of the face in the horizontal direction.

In the present disclosure, the type, placement, the number, and the like of the members are not limited to the above-described embodiments, and the constituent elements thereof may be appropriately replaced with ones having the same effect and effect and may be appropriately changed without departing from the gist of the invention.

Specifically, in Embodiments 1 to 4, the direction or inclination of the face in the vertical direction is corrected, but the direction and inclination of the face in the horizontal direction may be corrected by using Expression (12).

$$[ \begin{matrix}X \\ Y \\ Z \\ 1\end{matrix} ] = [ \begin{matrix}1 & 0 & 0 & TX \\ 0 & 1 & 0 & TY \\ 0 & 0 & 1 & TZ \\ 0 & 0 & 0 & 1\end{matrix} ] [ \begin{matrix}cos θ y & 0 & sin θ y & 0 \\ 0 & 1 & 0 & 0 \\ - sin θ y & 0 & cos θ y & 0 \\ 0 & 0 & 0 & 1\end{matrix} ] [ \begin{matrix}1 & 0 & 0 & 0 \\ 0 & cos θ x & - sin θ x & 0 \\ 0 & sin θ x & cos θ x & 0 \\ 0 & 0 & 0 & 1\end{matrix} ] [ \begin{matrix}- .1 & - .1 & .1 & .1 \\ .1 & - .1 & - .1 & .1 \\ 0 & 0 & 0 & 0 \\ 1 & 1 & 1 & 1\end{matrix} ] \qquad ( 12 )$$

### INDUSTRIAL APPLICABILITY

The present disclosure is suitable for use as a facial authentication device that performs face authentication using a face image of a person as a subject.

### REFERENCE MARKS IN THE DRAWINGS

100, 200, 300, 400 FACIAL AUTHENTICATION DEVICE
101 IMAGING UNIT
102, 201 CAMERA SIGNAL PROCESSOR
103, 302, 401 UI CONTROLLER
104 DISPLAY
105, 301, 402 FEATURE AMOUNT CALCULATOR
106 FACE POSITION DETECTOR
107, 204 IMAGE CORRECTOR
109 FACE COLLATOR
110 LIGHTER
202 FACE INCLINATION DETECTOR
203 IR LIGHTER

1. A facial authentication device comprising:
a camera signal processor that acquires visible light image data from imaging data captured by a camera;
a feature amount calculator that extracts a portion of a face of a subject from an image of the visible light image data and calculates a feature amount of the face;
a face position detector that detects a center position of the face in the image based on the feature amount of the face; and
an image corrector that estimates an orientation of the face based on the center position of the face and a position of the camera and corrects an image distortion of the visible light image data including an optical axis deviation such that the orientation of the face coincides with an optical axis direction of the camera to acquire the corrected image data,
wherein the feature amount calculator calculates a feature amount of the face from the corrected image data, the device further comprising:
a face collator that performs face recognition by collating the feature amount of the face calculated from the corrected image data with a feature amount of a face image registered in advance.

2. The facial authentication device of claim 1,
wherein the camera signal processor acquires distance image data from the imaging data, the device further comprising:
a face position detector that detects an inclination of the face of the subject based on the distance image data and the visible light image data, and
wherein the image corrector acquires the corrected image data using the inclination of the face of the detected subject.

3. The facial authentication device of claim 1,
wherein the feature amount calculator repeatedly calculates a length and/or a width of a face in the image based on the feature amount according to a motion of in the direction of the face of the subject to acquire an image in which the length and/or the width of the face is the longest as a best shot, the device further comprising:
a UI controller that executes display control processing for displaying an image of the visible light image data and information on whether or not the best shot has been acquired on a display, and
wherein the face position detector detects a center position of the face in the best shot.
